(19) United States
(12) Patent Application Publication
(10) Pub. No.: US 2013/0019185 A1
(43) Pub. Date: Jan. 17, 2013

(54) Method, Devices and a System for Communication

(71) Applicant: Ning Zhang, Beijing (CN)

(72) Inventor: Ning Zhang, Beijing (CN)

(73) Assignee: NOKIA CORPORATION, Espoo (FI)

(21) Appl. No.: 13/637,108

(22) PCT Filed: Mar. 26, 2010
(86) PCT No.: PCT/CN10/00387

§ 371 Date: Sep. 25, 2012

(51) Int. Cl. G06F 15/16; G06F 3/01

(52) U.S. Cl. 715/752; 709/206

(57) ABSTRACT

The invention relates to methods, devices, services and systems for composing a message, where forming the message utilizes information of a planned encounter and related location information. The user may choose one or more people, and give encounter information for example by indicating the type of a location where the encounter is planned. The message is then composed at least partly automatically by using this information on people and the encounter, and a location may be chosen and a route to the location may be formed so that the encounter can be arranged. This information is inserted into the message being composed.

### BACKGROUND

Contemporary internet services together with smart user devices make it possible for people to stay connected to friends and colleagues almost regardless of time and place. These services and devices may allow sending various kinds of messages like e-mails, consume content like music and videos, find the user's location on a digital map, and naturally making voice and video calls. These services have a myriad of useful features, and using the large number of services and features has become demanding and time-consuming.

There is, therefore, a need for a solution that makes it easier and faster to use the various services offered to users of smart devices.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

There is provided a method, devices and a system for composing a message, where forming the message utilizes information of a planned encounter and related location information. The user may choose one or more people, and give encounter information for example by indicating the type of a location where the encounter is planned. The message is then composed at least partly automatically by using this information on people and the encounter, and a location may be chosen and a route to the location may be formed so that the encounter can be arranged. This information is inserted into the message being composed.

According to a first aspect, there is provided a method for composing a message, comprising electronically receiving identification of at least one person, electronically receiving encounter information, wherein said encounter occurs in the future, electronically determining location information using said identification and said encounter information forming a message using said identification and said location information. According to an embodiment, the method further comprises forming a geographical route using said location information from said identification and said encounter, and forming said message using said route. According to an embodiment, the method further comprises receiving a message, and determining at least one of said identification, said encounter information and said location information from said message. According to an embodiment, the method further comprises forming said message using at least one of the group of a route calculation algorithm, an advertisement algorithm, phonebook information, calendar information and map information. According to an embodiment, the method further comprises receiving said identification of at least one person and said encounter information from a user by a selection on a user interface such as a touch screen user interface or a key-operated user interface. According to an embodiment, the method further comprises graphically converging said identification of at least one person and said encounter information on a user interface using a drag-and-drop operation, and based on said converging, determining said location information. According to an embodiment, the method further comprises forming history data from at least one of said identification of a person, said encounter information and said location information, and utilizing said history data in forming said message. According to an embodiment, the method further comprises determining location information of a plurality of places arranging said location information based on a criterion, and receiving information on location choice from a user.

According to a second aspect, there is provided an apparatus comprising a processor, memory including computer program code, the memory and the computer program code configured to, with the processor, cause the apparatus to receive identification of at least one person, receive encounter information, wherein said encounter occurs in the future, determine location information using said identification and said encounter information form a message using said identification and said location information. According to an embodiment, the apparatus further comprises computer program code configured to, with the processor, cause the apparatus to form a geographical route using said location information from said identification and said encounter, and form said message using said route. According to an embodiment, the apparatus further comprises computer program code configured to, with the processor, cause the apparatus to receive a message, and determine at least one of said identification, said encounter information and said location information from said message. According to an embodiment, the apparatus further comprises computer program code configured to, with the processor, cause the apparatus to form said message using at least one of the group of a route calculation algorithm, an advertisement algorithm, phonebook information, calendar information and map information. According to an embodiment, the apparatus further comprises a user interface such as a touch screen user interface or a key-operated user interface or a voice control user interface and computer program code configured to, with the processor, cause the apparatus to receive said identification of at least one person and said encounter information from a user by a selection on the user interface. According to an embodiment, the apparatus further comprises computer program code configured to, with the processor, cause the apparatus to graphically converge said identification of at least one person and said encounter information on a user interface using a drag-and-drop operation, and based on said converging, determine said location information. According to an embodiment, the apparatus further comprises computer program code configured to, with the processor, cause the apparatus to form history data from at least one of said identification of a person, said encounter information and said location information, and utilize said history data in forming said message. According to an embodiment, the apparatus further comprises computer program code configured to, with the processor, cause the apparatus to determine location information of a plurality of places arrange said location information based on a criterion, and receive information on location choice from a user. According to an embodiment, the apparatus further comprises a display, an input module for receiving user input, and a communication interface, and the apparatus is configured to receive said identification of at least one person and said encounter information using said input module and the apparatus is configured to display said message using said display.

According to a third aspect, there is provided a system comprising at least one processor, memory including computer program code, the memory and the computer program code configured to, with the at least one processor, cause the system to receive identification of at least one person, receive encounter information, wherein said encounter occurs in the future, determine location information using said identification and said encounter information form a message using said identification and said location information.

According to a fourth aspect, there is provided an apparatus comprising means for receiving identification of at least one person, means for receiving encounter information, wherein said encounter occurs in the future, means for determining location information using said identification and said encounter information means for forming a message using said identification and said location information.

According to a fifth aspect, there is provided a network service comprising an interface for receiving identification of at least one person, receiving encounter information, wherein said encounter occurs in the future, determining location information using said identification and said encounter information forming a message using said identification and said location information.

According to a sixth aspect, there is provided a computer program product stored on a computer readable medium and executable in a data processing device, the computer program product comprising a computer program code section for receiving identification of at least one person, a computer program code section for receiving encounter information, wherein said encounter occurs in the future, a computer program code section for determining location information using said identification and said encounter information a computer program code section for forming a message using said identification and said location information.

### DRAWINGS

In the following, various embodiments of the invention will be described in more detail with reference to the appended drawings, in which

FIG. 1 shows a flow diagram of a method for communication according to an example embodiment;

FIGS. 2a and 2b show a system and devices for enhancing communication according to an example embodiment;

FIG. 3 shows a block diagram of a system for enhancing communication according to an example embodiment;

FIG. 4 shows a flow diagram of a method for enhancing communication with suggestion and route information according to an example embodiment;

FIG. 5 shows a flow diagram of a method for enhancing communication with suggestion and route information together with a user preference according to an example embodiment;

FIG. 6 shows a flow diagram of a method for enhancing communication with suggestion and route information based on a received message according to an example embodiment;

FIG. 7a shows an example implementation of a user interface for controlling a method and a device for enhancing communication with suggestion and route information;

FIG. 7b shows an example implementation of a user interface for selecting a route algorithm for a method and a device for enhancing communication with suggestion and route information;

FIG. 8a shows an example implementation of a user interface for controlling a method and a device for enhancing communication with suggestion and route information using a received message;

FIG. 8b shows an example implementation of a user interface for generating a message by a method and a device for enhancing communication with suggestion and route information;

### DESCRIPTION OF THE EXAMPLE EMBODIMENTS

In the following, several embodiments of the invention will be described in the context of messaging in mobile communications and Internet services. It is to be noted, however, that the invention is not limited to messaging or the mobile or internet contexts. In fact, the different embodiments have applications widely in any environment where enhanced utilization contextual information (e.g. location information) and/or communication between people is required.

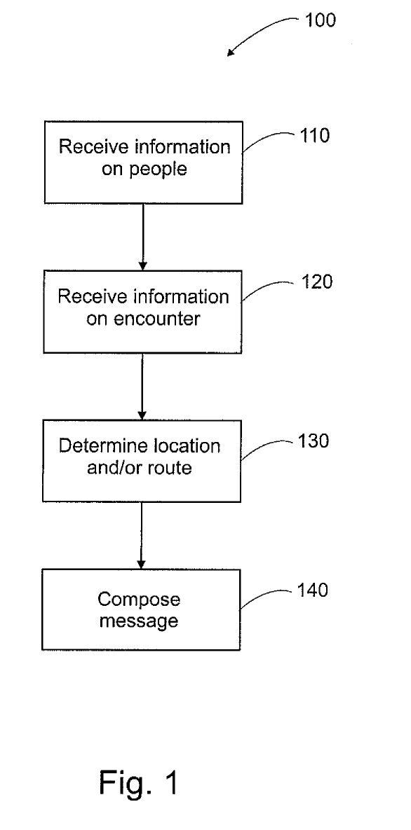

FIG. 1 shows a flow diagram of a method 100 for communication according to an example embodiment. In phase 110, information on related people is received. This receiving may happen through a user interface such as a touch screen or a keypad or a voice control mechanism, or for example a message may be received that has sender and receiver information or names of people in the message body. In one example embodiment a user interface may be voice controlled. A phonebook application may also be used for this purpose of receiving people information. In phase 120, information on an encounter is received. This may happen for example so that a user defines through the user interface that he would like to arrange a rendezvous or a meeting in the future, with the earlier defined people.

The defining may happen e.g. using a calendar through the user interface or by picking or automatically parsing this information from a received message. In defining the encounter, information about a place or a location, or the type of surroundings may be given or determined.

In phase 130, the location or venue is determined, and a route for one or more people to this location may be formed, as well. In the determination of the location and/or the route, the present or future location of the people defined in 110 and the encounter information like the type of location defined in 120 may be used. There may e.g. be provided a software application that convergences the contacts information and the user specified location information. For example, the facilities near to a specified contact in the phonebook may be determined automatically so that it's easy to meet him/her in an appreciated place. In phase 140, a message like a short message (SMS), multimedia message (MMS) or an email may be made to contain suggested places for a contact in the phonebook where the person may be interested in so that a meeting or a party can be easily scheduled. The people who are in the phonebook and live near a specified place may also be determined so that it is easy to arrange a meeting/party of the neighboring contacts. The application may summarize all the related information defined by the user in a report and/or message format to make it easy to use and share the information. One of the advantages of this and other embodiments may be that one user interface and/or one application may be used to control the operation and the user may not have to manually launch several applications to gather and specify the information, which may be time-consuming and difficult for the user.

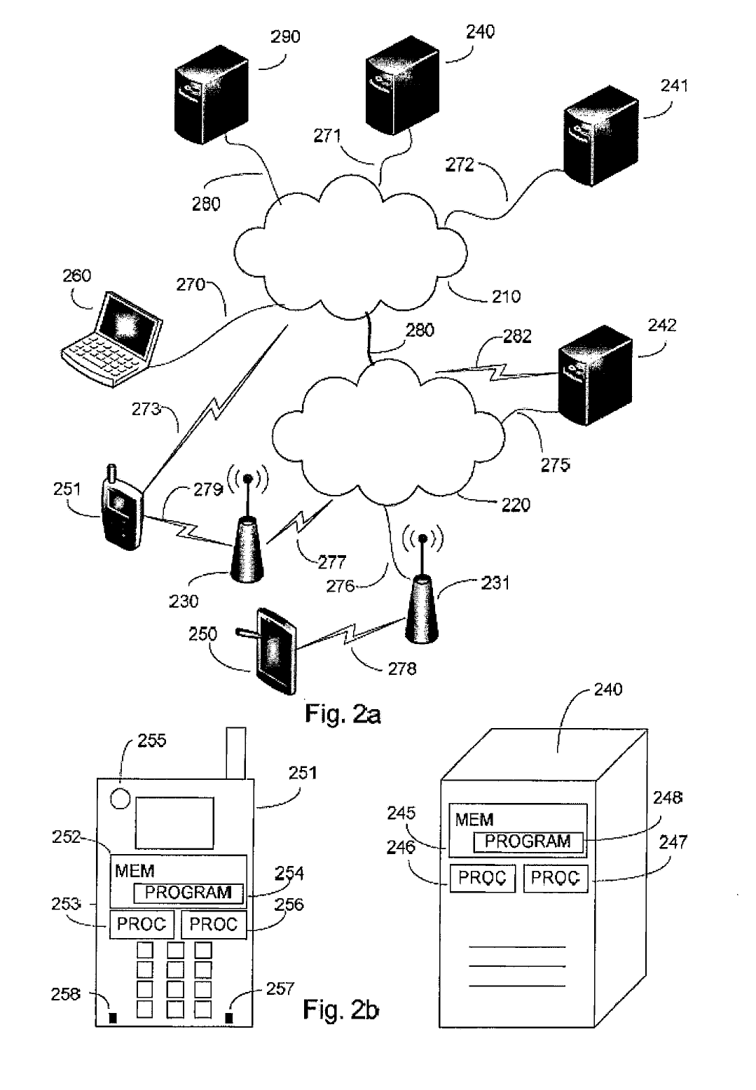

FIG. 2a shows a system and devices for enhancing communication according to an example embodiment. The different devices are connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There are a number of servers connected to the network, and here are shown a server 240 for storing and providing encounter information and/or people information and connected to the fixed network 210, a server 241 for providing location and/or map information and connected to the fixed network 210 and a server 242 for providing location and/or map information and connected to the mobile network 220. There are also a number of computing devices 290 connected to the networks 210 and/or 220 that are there for storing data and providing access to the data via, for example, a web server interface or data storage interface or such, and for providing access to other devices. Some of the above devices, for example the computers 240, 241, 242, 290 may be such that they make up the Internet with the communication elements residing in the fixed network 210.

There are also a number of end-user devices such as mobile phones and smart phones 251, Internet access devices (Internet tablets) 250 and personal computers 260 of various sizes and formats. These devices 250, 251 and 260 can also be made of multiple pads. The various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 2b shows devices for receiving people and encounter information, for determining a location and for composing a message according to an example embodiment. As shown in FIG. 2b, the server 240 contains memory 245, one or more processors 246, 247, and computer program code 248 residing in the memory 245 for implementing, for example, phone book functionality or positioning and map functionality and/or messaging functionality. The different servers 241, 242, 290 may contain at least these same elements for employing functionality relevant to each server. Similarly, the end-user device 251 contains memory 252, at least one processor 253 and 256, and computer program code 254 residing in the memory 252 for implementing, for example, phone book functionality or positioning and map functionality and/or messaging functionality. The end-user device may also have at least one camera 255 for taking pictures. The end-user device may also contain one, two or more microphones 257 and 258 for capturing sound. The different end-user devices 250, 260 may contain at least these same elements for employing functionality relevant to each device. Some end-user devices may be equipped with a digital camera enabling taking digital pictures, and one or more microphones enabling audio recording during, before, or after taking a picture.

It needs to be understood that different embodiments allow different parts to be carried out in different elements. For example, the forming of the message may be carried out entirely in one user device like 250, 251 or 260, or the forming of the message may be entirely carried out in one server device 240, 241, 242 or 290, or the forming of the message may be carried out across multiple user devices 250, 251, 260 or across multiple network devices 240, 241, 242, 290, or across user devices 250, 251, 260 and network devices 240, 241, 242, 290. The forming of the message may be implemented as a software component residing on one device or distributed across several devices, as mentioned above, for example so that the devices form a so-called cloud. The forming of the message may also be a service where the user accesses the message service through an interface, for example, using a browser. In a similar manner, the receiving of the people information, the encounter information and determining the location may be implemented with the various devices in the system.

The different embodiments may be implemented as software running on mobile devices and optionally on services. The mobile phones may be equipped at least with a memory, processor, display, keypad, motion detector hardware, and communication means such as 2G, 3G, WLAN, or other. The different devices may have hardware like a touch screen (single-touch or multi-touch) and means for positioning like network positioning or a global positioning system (GPS) module. There may be various applications on the devices such as a calendar application (scheduler, organizer or any application which can save and remind of the user's appointments), a contacts application (a phonebook application which can save the user's people and location data, e.g. office/home locations), a map application, a messaging application (for sending/receiving messages), a browser application (for viewing internet pages and other content), a route calculation algorithm plug-in or application (e.g.: shortest distance route selection), an advertisement plug-in or application and so on. There may be databases for storing location data and history data.

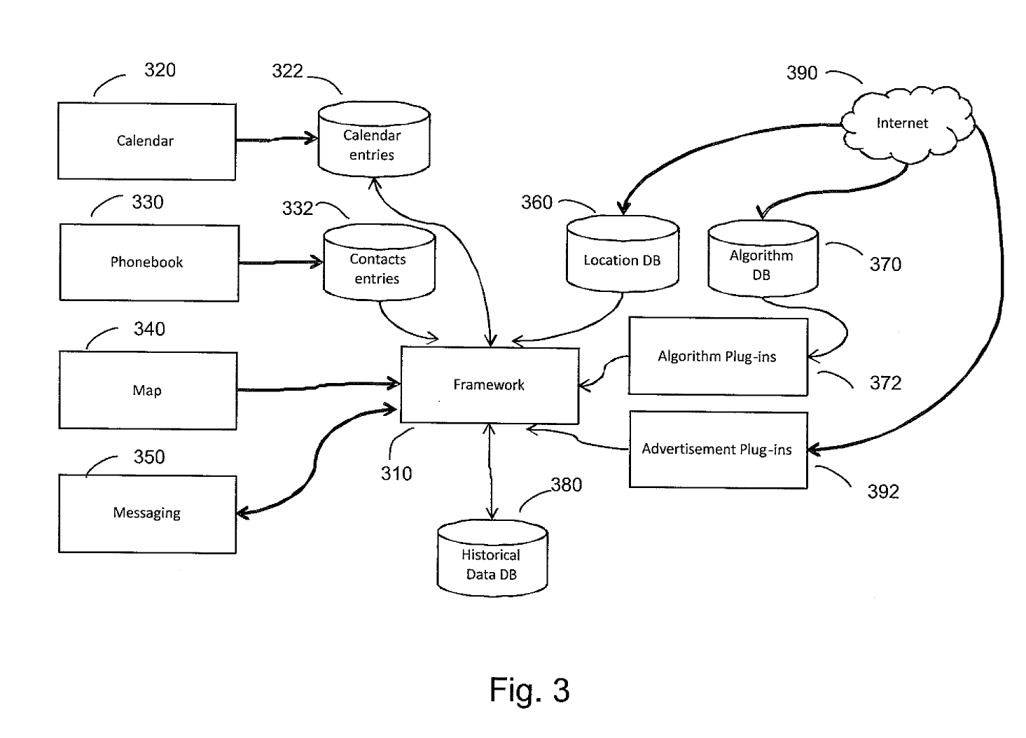

FIG. 3 shows a block diagram of a system for enhancing communication according to an example embodiment. At the center of the block diagram, there is a framework 310, a module that may collect and combine the information and algorithms from different sources. The system may comprise different objects stored in various data stores and applications. An object can e.g. be a contact, a restaurant, a weather station, an office building, a museum, a theater, or any contact and location beside these examples above that stored in the user's device or in the network. The object may contain fields for the object identifier, addresses, phone numbers and other data related to the object. The system may e.g. comprise a calendar application 320 providing a set of calendar entries 322 for the framework 310. The system may comprise a phonebook application 330 providing a set of contact entries 332 for the framework 310. The system may also comprise a map application 340 providing landmark and location information as well as route information. There may be a messaging application 350 providing messaging functionality for receiving, composing and sending messages.

Location information 360 may be obtained e.g. from the internet 390 either directly to the device or the system, or by downloading it via the computer. Location information 360 may also be provided on a memory device. The system may also collect and store history information on earlier entries, e.g. so that when certain contacts have been involved in an encounter at a certain location, this information is stored in the history database 380. When an encounter is then planned again for at least some of the contacts, the history database can be used to suggest e.g. the location and/or the type of the location.

The system may comprise a capability for accepting plug-ins. Plug-ins may be used e.g. for computing or determining the route information for the contacts for a certain encounter. The algorithm plug-in module 372 may comprise pre-loaded plug-ins (or fixed algorithms) as well as plug-ins from an algorithm database 370. These plug-ins may then be used to determine route information for an encounter, and this information may be sent to the attendants of the encounter. Plug-ins may also be used for obtaining advertisement information. For example, the framework may use an advertisement plug-in 392 for finding out advertisements relating to a location and/or type of location that relates to a specific encounter. These advertisements may then be used in the framework to display information to the user on possible locations and/or routes for the encounter. For example, if a user is arranging a meeting of friends at an internet café, the advertisement plug-in may fetch advertisements for internet cafés in the vicinity of the friends and these advertisements may be displayed to the user, possibly along with other information such as locations from the location database 360.

Route calculation may be done by the plug-ins or fixed algorithms as follows. The route calculation is generated by matching algorithm plug-in(s) which can be downloaded and selected according to the user's preference. There may be initially e.g. the following two matching algorithm plug-ins. Shortest distance algorithm uses two object addresses (one is the source and the other is the destination place) and adjusts the route by the actual city street/road/highway layout. Lowest expense algorithm uses two object addresses with data of bus/train/taxi expense to determine the route. There may also be a dynamic matching algorithm plug-in based on shortest time, where the initial route is generated by two object addresses and adjusted based on traffic and speed (e.g. speed limit or congestion) information. Allowing the plug-ins to be selectable may have advantages. Different cities may have different situations, e.g. in some crowded city like Beijing people may like to use a plug-in with real time traffic info so that the user would choose the shortest time, while some small towns do not have a traffic problem and a simpler algorithm may be used in order to save processing time. Also, different cites may have a different mathematic model for route selection.

The route may have the following presentation: To <somewhere> By <Method(s)>, Cost <Time>, and the contents may be for example “take bus #1 at the station A and get off at station B, then transfer to bus #2 and get off at station C. Finally, walk along about 100 meters and the restaurant D is at your right hand side. The whole trip will take about 35 minutes”. Alternatively or in addition, the route may be marked on the map.

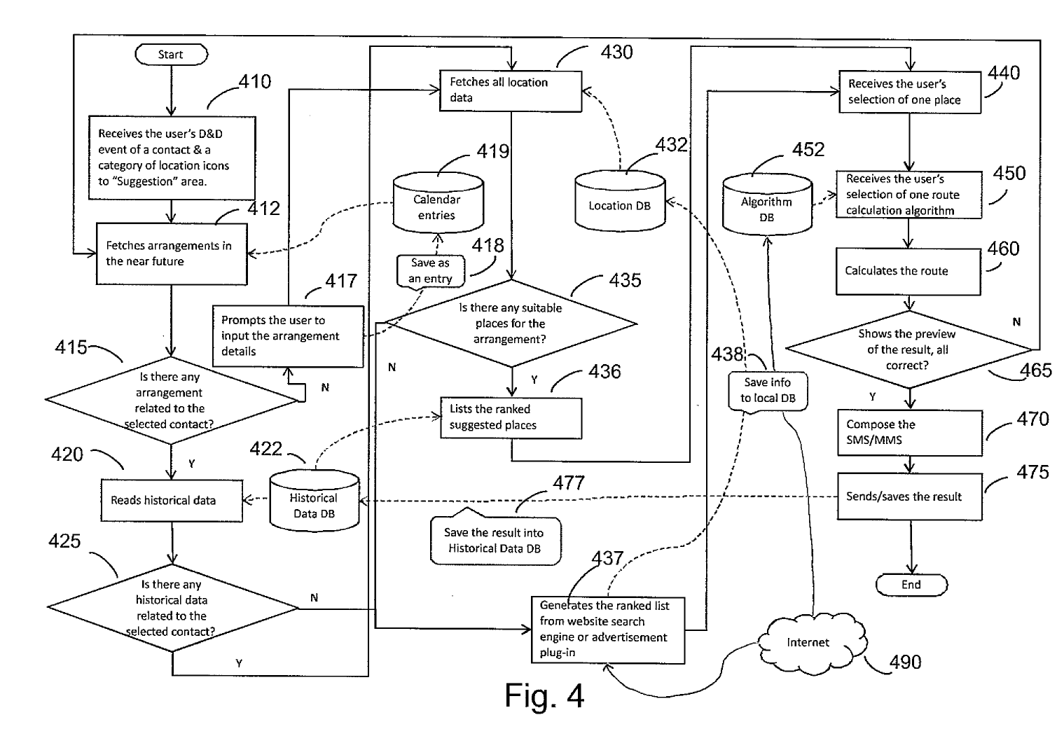

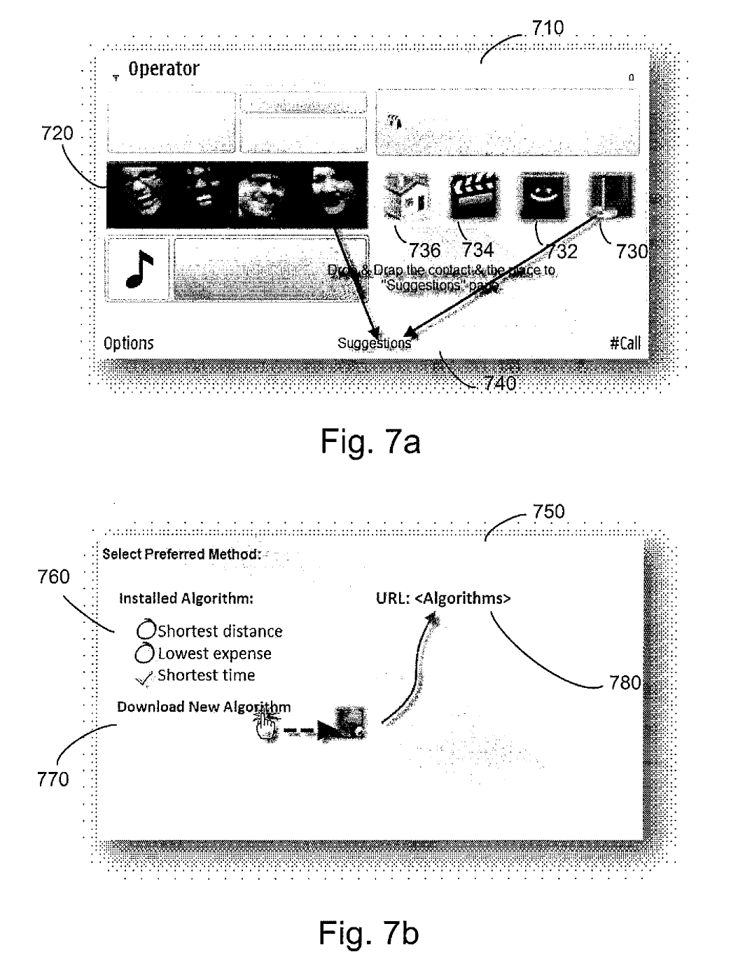

FIG. 4 shows a flow diagram of a method for enhancing communication with suggestion and route information according to an example embodiment. In phase 410, the system receives the user's drag & drop (D&D) event of one contact icon & one category of location icon to the “Suggestion” area (see FIG. 7 for details). In phase 412, the system fetches arrangements (meetings) in the near future with the contact, and then receives the user's selection for one of them. For example, the meetings happening within a time period from the present moment, e.g. 3 days by default and customizable. If there is no meeting related to the contact in 415, the system requests 417 the user to input the meeting details. These details may be saved in 418 as a calendar entry to a calendar database 419.

Next, the system moves on to determine the encounter details. The system may attempt to find history data in 420 from a history database 422 related to the contact and/or meeting. If the system cannot find any history data in phase 425, the system may perform a web search or fetch suitable advertisements to generate a ranked list of locations in 437. The system may also perform the step 437 in any case even if there is history data available. The device may analyze the history data that is related to the contact, fetch all location data, list the suitable places and prioritize them by frequency of visitation. The user may specify the location also by category such as teahouse, restaurant, or hotel rather than Bamboo Teahouse, Beijing Restaurant, or Hilton Hotel.

Next, the system determines the location data, e.g. by latitude & longitude or other coordinates, for the places. This may be done by 430 fetching the data from a location database 432. The location database may receive 438 data from the internet 490 by a web search engine and/or an advertisement plug-in operated in 437. In step 435, the system may check if there are any suitable places for arranging the encounter, e.g. a teahouse is suitable for discussing a business plan but a gym is not. The matching criteria may be pre-set values, may be customized and/or they may be downloaded from a service. Next, the suggested and ranked places (ranking may happen based on history data) are listed in phase 436.

Next, the system moves on to determine the route to the location of the encounter. First, the user's selection from the list(s) 436 and/or 437 is received in 440. Then (or at an earlier time, or by a default choice), the user's choice of a route determination algorithm (shortest time, shortest distance, etc.) is received in 450 e.g. from a local database 452. The device may list all installed route calculation algorithm plug-ins for the user's selection, and the default option may be the previous selection of the user. The local database 452 may receive 438 the route calculation algorithms from the internet. In phase 460, the route is calculated and may be formed as a textual route (directions) or on a map. Besides the recommended route, the marks of bus/train stations, public toilets and information centers are also drawn on the map if the user prefers. A voice guide and pictures may also be attached: the picture may be a snapshot of the destination place and the famous buildings/roads/etc for the receiver's reference. In phase 465, a preview of the route and the location of the encounter may be shown, and if the information is correct, a message is composed in 470. If the details are not acceptable, the process restarts from phase 412. When the message and details have been composed, the message may be sent 475 and the details saved 477 into the history database. The message may be sent e.g. via SMS expressed in text or MMS expressed in voice guide and pictures, or an e-mail or any other kind of a message.

The framework application may record the history for future reference, e.g. in the following format:
Favorites.contact.id=1234
Favorites.contact.museum.id=5678
Favorites.contact.museum.times=3
Favorites.contact.theater.id=9012
Favorites.contact.theater.times=2

By recording the history, the system may prompt the user for the recorded places if another encounter is to be planned. These data may also be used for the filtered advertisement presented to the user, if the user agrees to the use of his/her data by an advertiser. The advertisement may be filtered by the historical data e.g. as follows. When the user clicks “restaurant” keyword in SMS/MMS/Note, etc, the advertisement plug-in may provide advertisement information according to the existing data. The user may prefer restaurants of a certain type, and the advertisement plug-in may suggest more restaurants of the same type, and show any offers. The user may prefer a special food, and the advertisement plug-in may suggest some best restaurants where they have this special food. In addition to numeric history records, preferences of the contact may also be used, e.g. the contact's hobby, favorite movies/places.

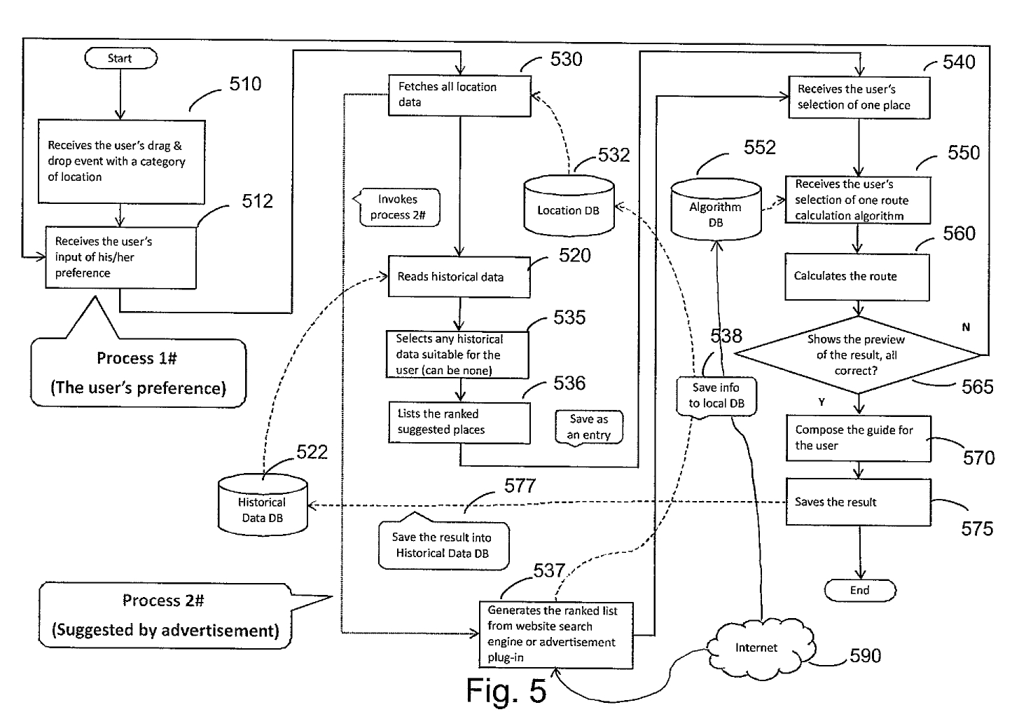

FIG. 5 shows a flow diagram of a method for enhancing communication with suggestion and route information together with a user preference according to an example embodiment. In phase 510, the system receives the user's drag & drop event of a category of a location icon to the “Suggestion” area (see FIG. 7 for details). In phase 512, the system queries the user's preference and generates the ranked suggestion list in the same way as above. The user's preferences may be e.g. the user's favorite movie type like “sci-fi”, or the user's favorite dish like “fish”, or the user's favorite relaxing place like “gym” and so on.

Preferences may also be combined to sets of preferences. Based on the user's preference(s), location data is fetched in 530.

The system may attempt to find history data in 520 from a history database 522 related to the contact and/or meeting. If the system cannot find any history data in phase 520 the system may perform a web search or fetch suitable advertisements to generate a ranked list of locations in 537. The system may also perform the step 537 in any case even if there is history data available. The device may analyze the history data that is related to the contact, fetch all location data, list the suitable places and prioritize them by frequency of visitation. The user may specify the location also by category such as teahouse, restaurant, or hotel rather than Bamboo Teahouse, Beijing Restaurant, or Hilton Hotel.

Next, the system determines the location data, e.g. by latitude & longitude or other coordinates, for the places. This may be done by fetching the data from a location database 532. The location database may receive 538 data from the internet 590 by a web search engine and/or an advertisement plug-in operated in 537. In step 535, the system may check if there are any suitable places for arranging the encounter, e.g. a teahouse is suitable for discussing a business plan but a gym is not. The matching criteria may be pre-set values, may be customized and/or they may be downloaded from a service. Next, the suggested and ranked places (ranking may happen based on history data) are listed in phase 536.

Next, the system moves on to determine the route to the location of the encounter. First, the user's selection from the list(s) 536 and/or 537 is received in 540. Then (or at an earlier time, or by a default choice), the user's choice of a route determination algorithm (shortest time, shortest distance, etc.) is received in 550 e.g. from a local database 552. The device may list all installed route calculation algorithm plug-ins for the user's selection, and the default option may be the previous selection of the user. The local database 552 may receive 538 the route calculation algorithms from the internet. In phase 560, the route is calculated and may be formed as a textual route (directions) or on a map. Besides the recommended route, the marks of bus/train stations, public toilets and information centers are also drawn on the map if the user prefers. A voice guide and pictures may also be attached: the picture may be a snapshot of the destination place and the famous buildings/roads/etc for the receiver's reference. In phase 565, a preview of the route and the location of the encounter may be shown, and if the information is correct, a guide is composed in 570. If the details are not acceptable, the process restarts from phase 512. When the guide and details have been composed, the guide may be saved 575 and the details may be saved 577 into the history database.

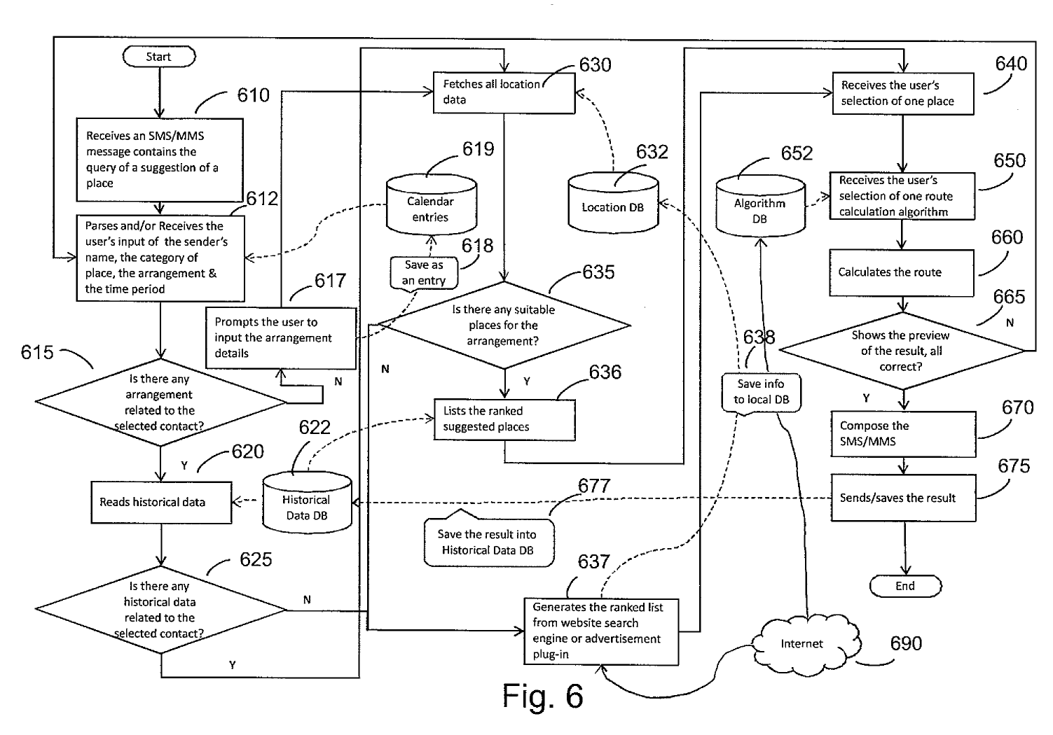

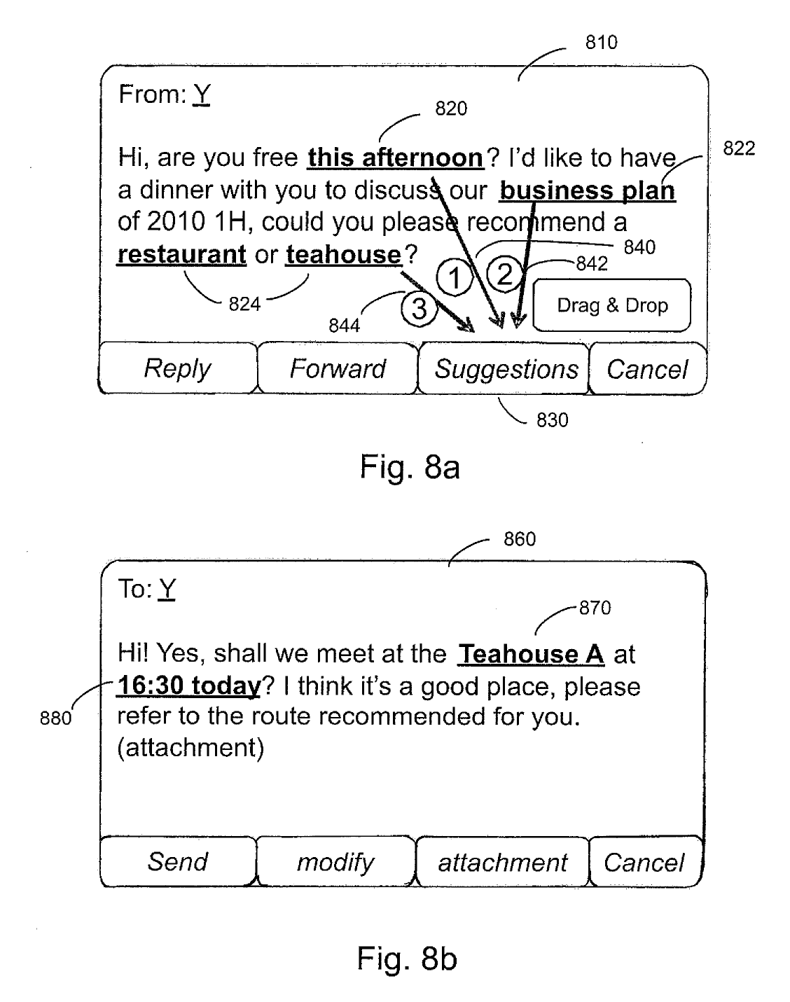

FIG. 6 shows a flow diagram of a method for enhancing communication with suggestion and route information based on a received message according to an example embodiment. In phase 610, the system receives a message containing a request for a suggestion of a place. The system may parse the sender's name, the category of the place, the meeting and the time period, and display the items e.g. by underlining or using some other highlighting method (see FIG. 8 for details). Keywords such as phone numbers, email address, URLs, etc in the message texts may be recognized for convenient selection for dialing, emailing or other operation. In a similar manner, keywords may be recognized for the present purpose. In an extended framework, the keywords may also be related to time e.g. “this afternoon” (linking to the user's schedule in Calendar application), to action e.g. “Discussing business plan” (also found in Calendar), a place e.g. Teahouse (linking to the places existing in the system e.g. in contact cards, map application etc.).

In phase 612, the system fetches arrangements (meetings) in the near future with the contact, and then receives the user's selection for one of them. For example, the meetings happening within a time period from the present moment, e.g. 3 days by default and customizable. If there is no meeting related to the contact in 615, the system requests 617 the user to input the meeting details. These details may be saved in 618 as a calendar entry to a calendar database 619.

Next, the system moves on to determine the encounter details. The system may attempt to find history data in 620 from a history database 622 related to the contact and/or meeting. If the system cannot find any history data in phase 625, the system may perform a web search or fetch suitable advertisements to generate a ranked list of locations in 637. The system may also perform the step 637 in any case even if there is history data available. The device may analyze the history data that is related to the contact, fetch all location data, list the suitable places and prioritize them by frequency of visitation. The user may specify the location also by category such as teahouse, restaurant, or hotel rather than Bamboo Teahouse, Beijing Restaurant, or Hilton Hotel.

Next, the system determines the location data, e.g. by latitude & longitude or other coordinates, for the places. This may be done by 630 fetching the data from a location database 632. The location database may receive 638 data from the Internet 690 by a web search engine and/or an advertisement plug-in operated in 637. In step 635, the system may check if there are any suitable places for arranging the encounter, e.g. a teahouse is suitable for discussing a business plan but a gym is not. The matching criteria may be pre-set values, may be customized and/or they may be downloaded from a service. Next, the suggested and ranked places (ranking may happen based on history data) are listed in phase 636.

Next, the system moves on to determine the route to the location of the encounter. First, the user's selection from the list(s) 636 and/or 637 is received in 640. Then (or at an earlier time, or by a default choice), the user's choice of a route determination algorithm (shortest time, shortest distance, etc.) is received in 650 e.g. from a local database 652. The device may list all installed route calculation algorithm plug-ins for the user's selection, and the default option may be the previous selection of the user. The local database 652 may receive 638 the route calculation algorithms from the Internet. In phase 660, the route is calculated and may be formed as a textual route (directions) or on a map. Besides the recommended route, the marks of bus/train stations, public toilets and information centers are also drawn on the map if the user prefers. A voice guide and pictures may also be attached: the picture may be a snapshot of the destination place and the famous buildings/roads/etc for the receiver's reference. In phase 665, a preview of the route and the location of the encounter may be shown, and if the information is correct, a message is composed in 670. If the details are not acceptable, the process restarts from phase 612. When the message and details have been composed, the message may be sent 675 and the details saved 677 into the history database. The message may be sent e.g. via SMS expressed in text or MMS expressed in voice guide and pictures, or an e-mail or any other kind of a message.

FIG. 7a shows an example implementation of a user interface for controlling a method and a device for enhancing communication with suggestion and route information. The user interface 710 may be implemented e.g. with a touch screen having single-point or multi-point capability or a usual mouse-operated user interface. The user interface contains an area of pictures or a list of names 720 of contacts or people's information from another source. The user interface also comprises an area or a list of location types and/or locations, for example a landmark 730, a theatre 732, a movie 734 and a home/office location 736. The user interface comprises a collection area or another kind of an attractor 740. The user can drag and drop people and location types to this “suggestion” area 740 and thereby define that an encounter with the people and the location type(s) should be arranged.

To arrange an encounter, the user drags and drops both of the selected contact and the preferred place (such as restaurant, theater, etc) to the suggestion area 740. The framework may then retrieve the address information of the contact and the place, and use the user selected algorithm to calculate the route. The route may then be sent to the contact, and if the user allowed, his/her own route can be also sent. Also additional information like the traffic info, local weather, and nearby facilities may be shown. Sometimes even the user himself may not know or be able to choose his destination from the suggestions, e.g. because he is in a strange city. The user would like to get to somewhere for the latest movie show, the latest clothes, or such. In this case, the system may generate the route to the suggested places.

To find the places that the user may prefer and that are suggested to the user, the system may ask questions from the user. For example, if the user would like to see the latest movie show, the system may ask (possibly via a plug-in) which style the movie would the user like (opera, sci-fi, war, romance etc.) and which environment would the user like (VIP-class, 3-D theater, etc.). The questions may be updated dynamically e.g. from the website that provided the plug-in such as the City's Information Office's website.

FIG. 7b shows an example implementation of a user interface 750 for selecting a route algorithm for a method and a device for enhancing communication with suggestion and route information. The user interface may show the installed algorithms 760 and allow the user to select the algorithm to be used. The interface may also offer a possibility to download a new algorithm 770, and may for that purpose offer also to select the location 780 where a new algorithm is selected.

FIG. 8a shows an example implementation of a user interface for controlling a method and a device for enhancing communication with suggestion and route information using a received message. In the figure, the application for composing a message displays a message 810 from person Y. The message includes information on a suggested time 820 (“this afternoon”), a topic 822 (“business plan”) and a type of location 824 (“restaurant or teahouse”). The user may drag and drop the time 840, the topic 842 and the location type 844 to an attractor or a bin called “suggestions” 830 in order to indicate that these data should be used in determining the encounter and forming a reply message. As explained earlier, the application determines suitable locations and may offer them for the user to choose. The application may also find a suitable time, e.g. based on the route and distance information.

FIG. 8b shows an example implementation of a user interface for generating a message by a method and a device for enhancing communication with suggestion and route information. In the figure, the application for composing a message displays a draft message 860 to be sent to the person Y. The message now comprises a location 870 (“Teahouse A”) that the person has chosen or that has been chosen automatically by the application. The message also contains a time 880 (“16:30 today”) determined by the application and/or chosen by the user. In addition, the message may comprise textual and/or graphical information about the location and the route to the location. The route may be shown for person Y and other attendants, for the sender, or both.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1. A method for composing a message, comprising:
electronically receiving identification of at least one person,
electronically receiving encounter information, wherein said encounter occurs in the future,
electronically determining location information using said identification and said encounter information, and
forming a message using said identification and said location information.

2. A method according to claim 1, further comprising:
forming a geographical route using said location information from said identification and said encounter, and
forming said message using said route.

3. A method according to claim 1, further comprising:
receiving a message, and
determining at least one of said identification, said encounter information and said location information from said message.

4. A method according to claim 1, further comprising:
forming said message using at least one of the group of a route calculation algorithm, an advertisement algorithm, phonebook information, calendar information and map information.

5. A method according to claim 1, further comprising:
receiving said identification of at least one person and said encounter information from a user by a selection on a user interface such as a touch screen user interface or a key-operated user interface.

6. A method according to claim 1, further comprising:
graphically converging said identification of at least one person and said encounter information on a user interface using a drag-and-drop operation, and
based on said converging, determining said location information.

7. A method according to claim 1, further comprising:
forming history data from at least one of said identification of a person, said encounter information and said location information, and
utilizing said history data in forming said message.

8. A method according to claim 1, further comprising:
determining location information of a plurality of places
arranging said location information based on a criterion, and
receiving information on location choice from a user.

9. An apparatus comprising a processor, memory including computer program code, the memory and the computer program code configured to, with the processor, cause the apparatus to perform at least the following:
receive identification of at least one person,
receive encounter information, wherein said encounter occurs in the future,
determine location information using said identification and said encounter information, and
form a message using said identification and said location information.

10. An apparatus according to claim 9, further comprising computer program code configured to, with the processor, cause the apparatus to perform at least the following:
form a geographical route using said location information from said identification and said encounter, and
form said message using said route.

11. An apparatus according to claim 9, further comprising computer program code configured to, with the processor, cause the apparatus to perform at least the following:
receive a message, and
determine at least one of said identification, said encounter information and said location information from said message.

12. An apparatus according to claim 9, further comprising computer program code configured to, with the processor, cause the apparatus to perform at least the following:
form said message using at least one of the group of a route calculation algorithm, an advertisement algorithm, phonebook information, calendar information and map information.

13. An apparatus according to claim 9, further comprising a user interface such as a touch screen user interface or a key-operated user interface and computer program code configured to, with the processor, cause the apparatus to perform at least the following:
receive said identification of at least one person and said encounter information from a user by a selection on the user interface.

14. An apparatus according to claim 9, further comprising computer program code configured to, with the processor, cause the apparatus to perform at least the following:
graphically converge said identification of at least one person and said encounter information on a user interface using a drag-and-drop operation, and
based on said converging, determine said location information.

15. An apparatus according to claim 9, further comprising computer program code configured to, with the processor, cause the apparatus to perform at least the following:
form history data from at least one of said identification of a person, said encounter information and said location information, and
utilize said history data in forming said message.

16. An apparatus according to claim 9, further comprising computer program code configured to, with the processor, cause the apparatus to perform at least the following:
determine location information of a plurality of places
arrange said location information based on a criterion, and
receive information on location choice from a user.

17. An apparatus according to claim 9, further comprising a display, an input module for receiving user input, and a communication interface, and wherein the apparatus is configured to receive said identification of at least one person and said encounter information using said input module and the apparatus is configured to display said message using said display.

18-36. (canceled)

37. A computer program product stored on a computer readable medium and executable in a data processing device, the computer program product comprising:
a computer program code section for receiving identification of at least one person,
a computer program code section for receiving encounter information, wherein said encounter occurs in the future,
a computer program code section for determining location information using said identification and said encounter information,
a computer program code section for forming a message using said identification and said location information.

38. A computer program product according to claim 37, wherein the computer program product further comprises:
a computer program code section for forming a geographical route using said location information from said identification and said encounter, and
a computer program code section for forming said message using said route.

39. A computer program product according to claim 37, wherein the computer program product further comprises:
a computer program code section for receiving a message, and
a computer program code section for determining at least one of said identification, said encounter information and said location information from said message.

40-44. (canceled)
